(19) United States
(12) Patent Application Publication
(10) Pub. No.: US 2024/0201652 A1
(43) Pub. Date: Jun. 20, 2024

(54) Contextualizing Editors During Engineering of a Process Plant

(71) Applicant: Siemens Aktiengesellschaft, Muenchen (DE)

(72) Inventor: Benjamin LUTZ, Pfinztal, (DE)

(21) Appl. No.: 18/288,623

(22) PCT Filed: Apr. 25, 2022
(86) PCT No.: PCT/EP2022/060933

§ 371 Date: Oct. 27, 2023

(30) Foreign Application Priority Data
Apr. 29, 2021 (EP) 21171285.6

(51) Int. Cl. G05B 19/409; G06F 3/0486

(52) U.S. Cl. CPC G05B 19/409; G06F 3/0486; G05B 2219/32128

(57) ABSTRACT

A computer-implemented configuration tool for configuring a plurality of process components of a process plant includes a first tool component and a second tool component, wherein the first tool component generates an automation of the process components for the process plant and is assigns to each process component, during the automation, a parameterisation and an interaction with further process components, and the second tool component generates an operation and observation for the process components of the process plant, where the configuration tool provides the second tool component with a process component, which is automated by the first tool component, with its parameterisation and its interaction with further process components, such that the second tool component is not required to make adjustments to the automated process component to integrate it into the operation and observation of the plurality of process components of the process plant.

### CROSS-REFERENCE TO RELATED APPLICATIONS

This is a U.S. national stage of application No. PCT/EP2022/060933 filed 25 Apr. 2022. Priority is claimed on European Application No. 21171285.6 filed 29 Apr. 2021, the content of which is incorporated herein by reference in its entirety.

### BACKGROUND OF THE INVENTION

### 1. Field of the Invention

The invention relates to an engineering station server for a control system of a process plant, a control system for the process plant, a method for generating operator control and monitoring of the process plant by a computer-implemented configuration tool and to a computer-implemented configuration tool for configuring a plurality of process components of a process plant comprising a first tool component and a second tool component, where the first tool component is configured to generate automation of the plurality of process components for the process plant, where the first tool component is also configured to assign parameterization and interaction with further process components to each process component in the context of automation, and where the second tool component is configured to generate operator control and monitoring for the plurality of process components of the process plant.

### 2. Detailed Description of the Related Art

Engineering efficiency plays a decisive role in the configuration of automation engineering for process engineering plants. Engineering efficiency can be measured by the time required to introduce changes or extensions; and systemic support with respect to error prevention in order avoid time spent on corrections.

Here, editors in engineering play a central role. Herein, particular importance is attached to the way in which these editors interact with one another in integrated engineering with cross-editor actions, such as automation of a measuring point. In the context of the automation of a measuring point, process objects belonging to process components of the process plant are created in the engineering, where their various facets are configured by different editors.

It is known that, when creating new measuring points, the automation functionality (in a control flowchart (CFC)) should first be configured before generating the operator control and monitoring required for this in plant diagrams.

When automating a measuring point using type-instance-based engineering, an instance of a process object (module facet) is created in a CFC (“drag & drop” of the process object type from the library into the CFC plan) and, on an instance-specific basis, interconnected with other process objects (in the CFC or cross-CFC), interconnected with signals from the hardware (actuators and sensors) interconnected with combinatorial/mathematic logic (for example, signal encoding) and parameterized (for example, regulator parameters).

For the operator control and monitoring of the measuring point, different graphical representations of the process object are created in plant diagrams, including:
Block symbols in different variants (compact/detailed): for this, in known automation solutions, the process that has already been instantiated must be sought and assigned (via “drag & drop”) to the respective plant diagrams.
I/O fields for the graphical output of individual process values: with known automations solutions, the I/O fields are taken from a library (via “drag & drop”) and allocated to the respective plant diagram (by graphical “dragging”)—herein, the process value to be displayed must be sought via “object pickers” with search masks based on the name of the process value to be displayed and the associated process object instance.
Trend displays for the graphical output of the history of individual process values: with known automation solutions, trend displays are taken from a library (via “drag & drop”) and allocated to the respective plant diagram (by graphical “dragging”)—herein, the process value to be displayed must be sought using so-called “object pickers” with search masks based on the name of the process value to be displayed and the associated process object instance.

As described by way of example, with conventional automation solutions, numerous and often also error-prone steps are necessary in order to configure new measuring points.

DE 10 305 637 A1 describes an automation solution in which measuring points are configured in an engineering phase of a process plant as explained above.

### SUMMARY OF THE INVENTION

It is an object of the invention to provide a computer-implemented configuration tool for configuring a process plant that enables efficient automation and generation of operator control and monitoring of the process plant.

This and other objects and advantages are achieved in accordance with the invention by a computer-implemented configuration tool for configuring a plurality of process components of a process plant, by an engineering station server for a control system of a process plant, by a control system for a process plant, by a method for generating operator control and monitoring of a process plant via a computer-implemented configuration tool, where the computer-implemented configuration tool is configured to provide the second tool component with a process component automated by the first tool component, along with its parameterization and its interaction with further process components, such that the second tool component is not required to make any adjustments to the automated process component in order to integrate it into the operator control and monitoring of the plurality of process components of the process plant.

The process plant can, for example, be a chemical, pharmaceutical, petrochemical plant or a plant from the food and beverage industries.

Process components can be any components, such as sensors or actuators, which communicate with one another in the process plant and/or with higher-level controlling components of the process plant and are used to generate a product in the process plant.

The first tool component of the computer-implemented configuration tool is used by a project engineer of the process plant to create automation. Automation is known per se and comprises at least the parameterization of process components and interaction of the process components with further process components.

The second tool component accesses the automated process components or process objects and creates an associated operator control and monitoring. Operator control and monitoring are known in the context of a process plant. They are used by operators of the process plant to observe and control the process plant with its process components. In the context of operator control and monitoring, it is usual for graphical representations of the process objects to be generated and displayed to operators via suitable visualization mechanisms (e.g., monitors, smartphones, and/or tablets).

As described in the introduction, with conventional computer-implemented configuration tools, interaction between the first tool component and second tool component is laborious and involves considerable effort for the project engineer. To date, in particular for measuring points, the project engineer has had to manually assign the necessary properties to the automated measuring point in the context of the generation of the operator control and monitoring and manually take over the parameters or the interactions with other process objects from the automation and assign them to the measuring point for the operator control and monitoring.

The configuration tool in accordance with the invention now significantly reduces the effort for the project engineer because the transfer of the automated process objects between the tool components is established in accordance with the invention. This enables efficient and error-free configuration of a process plant.

Herein, the computer-implemented configuration tool is configured to provide the second component tool with the automated process component via a displacement operation that can be triggered by a project engineer of the process plant, in particular a graphical dragging movement or a copy and paste operation. The project engineer can assign the process object automated in the first design tool to the second tool component, for example, via “drag & drop”. This then takes over parameterization and interactions in an automated manner and creates the operator control and monitoring of this process object.

“Copy & paste” of the automated process object is also possible.

The second tool component can be configured to offer the project engineer of the process plant a selection option on acceptance of the automated process component such that the project engineer can select a manifestation of the automated process component for the operator control and monitoring from a plurality of options. For example, on the integration of an automated measuring point, the project engineer can be offered a selection option allowing a choice to be made between the manifestations “trend diagram”, “spider diagram” and “scatter diagram”. However, it can also be provided that a most common manifestation is automatically provided for the operator control and monitoring of the previously automated process component and that the project engineer is additionally offered the selection option so that he can easily change the manifestation if necessary.

The objects and advantages are also achieved in accordance with the invention by an engineering station server for a control system of a process plant on which the configuration tool as explained above is computer-implemented.

In the present case, an “engineering station server” should be understood to be a server configured to create, manage, archive and document different hardware and software projects for a control system of a technical plant. Special software design tools (engineering toolset) and ready-made modules and plans enable the engineering station server to plan and manage the interaction of control devices and facilities in the process plant. This is also referred to as “engineering” or “configuration” of the process plant. An example of such an engineering station server is a SIMATIC Manager Server from SIEMENS.

The objects and advantages are also achieved in accordance with the invention by a control system for a process plant comprising at least one engineering station server and at least one operator station server, where the operator station server is configured to transmit operator control and monitoring of the process plant created by the computer-implemented configuration tool on the engineering station server to at least one operator station client for visual display.

In the present context, a control system should be understood to be a computer-aided technical system comprising functionalities for display, operator control and guiding control of the process plant. In addition to the operator station server, operator station client and engineering station server, the control system can, for example, also comprise process-related or production-related components that are used to actuate actuators or sensors.

In the present case, an “operator station server” should be understood to mean a server that centrally collects data from an operating and monitoring system and, as a rule, alarm and measured value archives from the control system of the process plant and provides them to users. As a rule, the operator station server establishes a communication link to automation systems (such as an automation device) of the process plant and forwards process plant data to “operator station clients” to be used for the operator control and monitoring of the operation of the individual functional elements of the process plant.

The operator station server can itself have client functions in order to access data (archives, messages, tags, variables) from other operator station servers. This enables diagrams of an operation of the process plant on the operator station server to be combined with variables of other operator station servers (server-server communication). The operator station server can be, but is not restricted thereto, a SIMATIC PCS 7 Industrial Workstation Server from SIEMENS.

The control system can comprise a first engineering station server and a second engineering station server, where the first tool component is computer-implemented on the first engineering station server and the second tool component is computer-implemented on the second engineering station server. Therefore, it is not necessary for the first tool component and the second tool component to be located on a single engineering station server. Particularly in the context of web-based control systems, which are becoming increasingly important, the different parts of the configuration tool can be implemented on different server infrastructures.

The objects and advantages are additionally achieved in accordance with the invention by a method for generating operator control and monitoring of a process plant by a computer-implemented configuration tool comprising:
a) generating automation of the plurality of process components for the process plant by a first tool component of the computer-implemented configuration tool, where, in the context of automation, the first tool component assigns parameterization and interaction with further process components to each process component,
b) provision of the automated process component, along with its parameterization and its interaction with further process components, for a second tool component of the computer-implemented configuration tool by the first tool component, and
c) generating operator control and monitoring for the plurality of process components of the process plant by the second tool component based on the automated process components obtained from the first tool component.

In accordance with the method of the invention, the first tool component in each case provides the second tool component with the automated process component, along with its parameterization and its interaction with further process components, such that the second tool component is not required to make any adjustments to the automated process component in order to integrate it in the operator control and monitoring of the plurality of process components of the process plant.

Herein, in a manner similar to that described previously, the automated process component can be provided to the second tool component by a displacement operation that can be triggered by a project engineer of the process plant, in particular a graphical dragging movement or a copy and paste operation.

In the context of an advantageous embodiment of the invention, the second tool component offers a project engineer of the process plant a selection option on acceptance of the automated process component such that the project engineer can select a manifestation of the automated process component for the operator control and monitoring from a plurality of options.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of the present invention and the manner in which they are achieved will become clearer and more readily understandable in connection with the following description of an exemplary embodiment, which will be explained in more detail in connection with the drawings, in which:

FIG. 1 shows a user interface of a first tool component of a computer-implemented configuration tool in accordance with the invention;

FIG. 2 shows a user interface of a second tool component of a computer-implemented configuration tool in accordance with the invention;

FIG. 3 shows a schematic view of an engineering station server; and

FIG. 4 is a flowchart of the method in accordance with the invention.

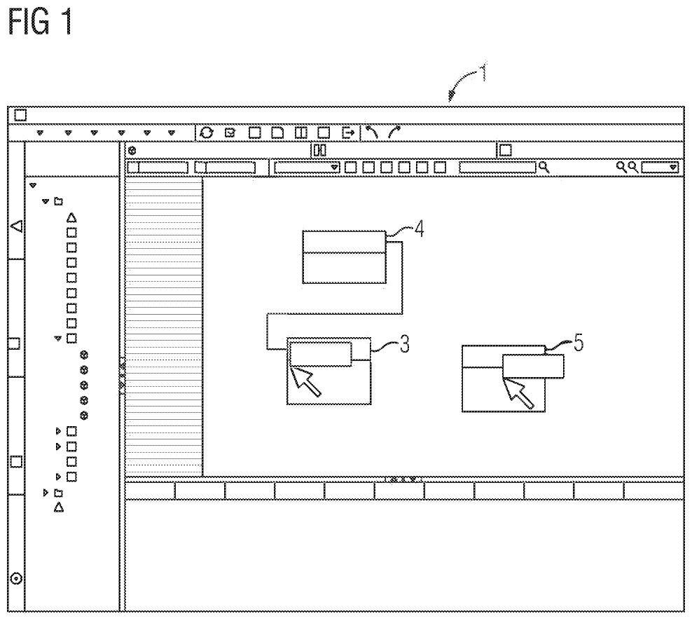

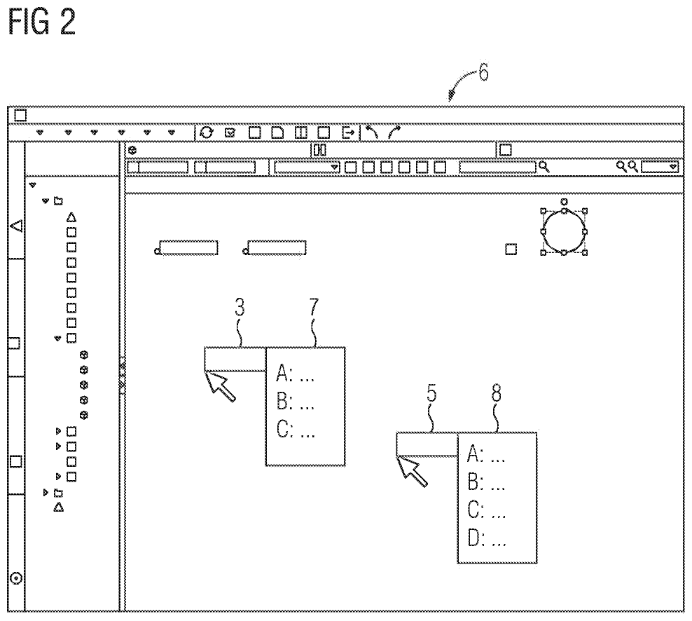

FIG. 1 shows a user interface of a first tool component 1 of a computer-implemented configuration tool. A first process object 2, which has been automated by a project engineer, represents a signal 3 at an interface of a functional module 4 of an arbitrary component of a process plant. A second process object 5 is considered to be a functional module of a further arbitrary component of the process plant. If the project engineer changes to a user interface of a second tool component 6 shown in FIG. 2 with the copied or mouse-held process objects 2, 5, then the project engineer can simply place the copied process objects 2, 5 (“paste” or “drop”).

Herein, the project engineer is offered a first selection option 7 (identified by “A: . . . ”, “B: . . . ” and “C: . . . ”) for the first process object 2 that the project engineer can use to select a manifestation of the process object 2 in the operator control and monitoring. Possible manifestations for the signal 3 of the functional module 4 are, for example, “I/O fields”, “trend displays” or “scatter diagrams”.

For the second process object 5, the project engineer is offered a second selection option 8 (identified by “A: . . . ”, “B: . . . ”, “C: . . . ” and “D: . . . ”) that the project engineer can use to select a manifestation of the second process object 5 in the operator control and monitoring. For example, the manifestation offered for the functional module 5, can be “block symbol variant” or “bar chart”.

It is not only possible to transfer individual process objects 2, 5 from the first tool component 1 to the second tool component 6. Rather, the project engineer can also select a large number of process objects 2, 5 for transfer.

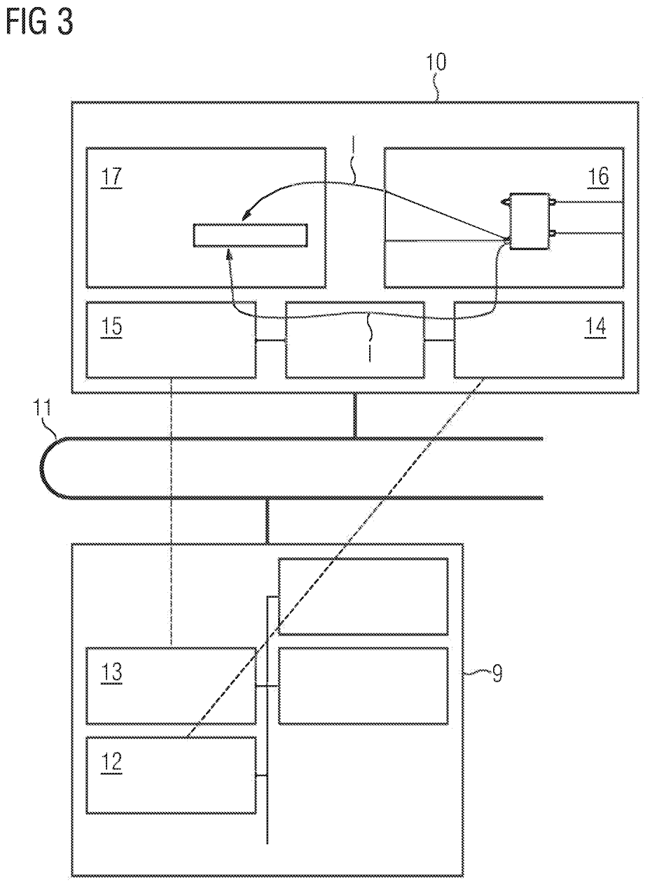

FIG. 3 shows a engineering station server 9 and an engineering station client 10 of a control system of a technical plant embodied as a process plant, i.e., as a process engineering plant. The engineering station server 9 and the engineering station client 10 are connected to one another via a terminal bus 11 and optionally to further components of the control systems 1 (not depicted), such as a process data archive or an operator station server.

A project engineer can access the engineering station server 9 via the engineering station client 10 via the terminal bus 11. The terminal bus 11 can, but is not restricted thereto, for example, be formed as an Industrial Ethernet.

A configuration tool with a first tool component 12 and a second tool component 13 is computer-implemented on the engineering station server 9. Corresponding user interfaces 16, 17 for the two tool components 12, 13 are displayed on the engineering station client 10 by visualization services 14, 15 in order to enable the project engineer to use the tool components 12, 13.

A displacement operation I enables automated process objects in the first tool component 12 to be transferred to the second tool component 13 (which is visualized accordingly on the user interfaces 16, 17). This enables the previously explained advantageous functionality to be achieved.

Although the invention has been illustrated and described in greater detail by the preferred exemplary embodiment, the invention is not restricted by the disclosed examples and other variations can be derived herefrom by the person skilled in the art without departing from the scope of protection of the invention.

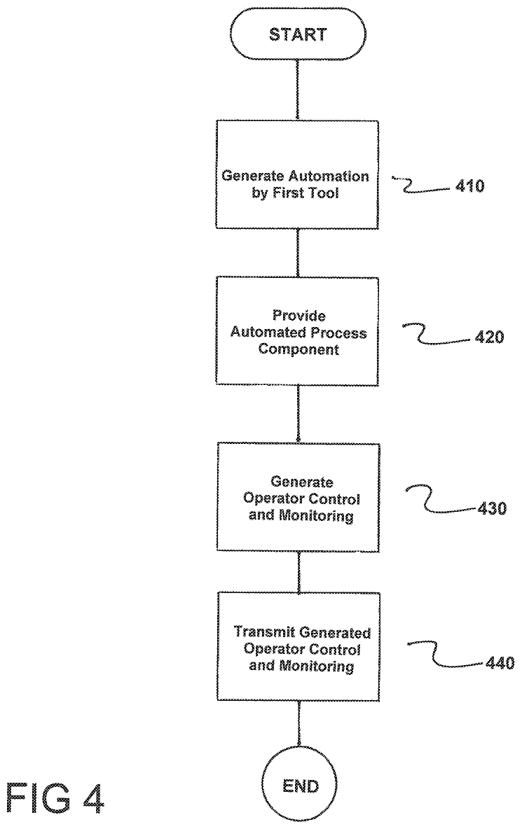

FIG. 4 is a flowchart of the method for displaying operator control and monitoring of a process plant via a computer implemented configuration tool implemented on an engineering station server.

The method comprises a) generating automation for a plurality of process components for the process plant by a first tool component 1 of the computer-implemented configuration tool, as indicated in step 410. In accordance with the method, the first tool component 1 assigns parameterization and interaction with further process components to each process component during generation of the automation.

Next, b) the automated process component, along with its parameterization and its interaction is provided with further process components, for a second tool component (6) of the computer-implemented configuration tool by the first tool component 1, as indicated in step 420.

Next, c) operator control and monitoring for the plurality of process components of the process plant is generated by the second tool component 6 based on the automated process components obtained from the first tool component 1, as indicated in step 430.

Next, d) the generated operator control and monitoring is transmitted to an operator station client of an operator station server of the process plant based on a previously generated operator control and monitoring and visual display of the operator control and monitoring via the operator station client, as indicated in step 440.

In accordance with the method, the first tool component 1 in each case provides the second tool component 6 with the automated process component, along with its parameterization and its interaction with further process components, such that the second tool component 6 is not required to make any adjustments to the automated process component in order to integrate the automated process component into the operator control and monitoring of the plurality of process components of the process plant. In accordance with the method, the automated process component is also provided to the second tool component (6) by a displacement operation that is triggerable by a project engineer of the process plant and represents a graphical dragging movement or a copy and paste operation. Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A computer-implemented configuration tool for configuring a plurality of process components of a process plant comprising a first tool component and a second tool component;
wherein the first tool component is configured to generate automation of the plurality of process components for the process plant;
wherein the first tool component is embodied to assign parameterization and interaction with further process components to each process component in the context of the generation of the automation;
wherein the second tool component is configured to generate operator control and monitoring for the plurality of process components of the process plant;
wherein the computer-implemented configuration tool is configured to provide the second tool component with a process component automated by the first tool component, along with its parameterization and its interaction with further process components, such that the second tool component is not require to make any adjustments to the automated process component in order to integrate the automated process component into the operator control and monitoring to be generated of the plurality of process components of the process plant;
wherein the computer-implemented configuration tool is further configured, in a context of the generation of the automation, to provide the second tool component with the automated process component by a displacement operation which is triggerable by a project engineer of the process plant and represents a graphical dragging movement or a copy and paste operation; and
wherein the computer-implemented configuration tool is further configured to transmit the generated operator control and monitoring to an operator station client of an operator station server of the process plant, a visual display of the operator control and monitoring occurring via the operator station client based on the previously generated operator control and monitoring.

9. The computer-implemented configuration tool as claimed in claim 8, wherein the second tool component is configured to offer the project engineer of the process plant a selection option upon acceptance of the automated process component such that the project engineer can select a manifestation of the automated process component for the operator control and monitoring from a plurality of options.

10. An engineering station server for a control system of a process plant on which the configuration tool according claim 8 is computer-implemented.

11. A first engineering station server and a second engineering station server, the first and second engineering station servers being for a control system of a process plant, on which a configuration tool in accordance with claim 8 is computer-implemented, wherein the first tool component of the configuration tool is computer-implemented on the first engineering station server and the second tool component is computer-implemented on the second engineering station server.

12. A first engineering station server and a second engineering station server, the first and second engineering station servers being for a control system of a process plant, on which a configuration tool in accordance with claim 9 is computer-implemented, wherein the first tool component of the configuration tool is computer-implemented on the first engineering station server and the second tool component is computer-implemented on the second engineering station server.

13. A control system for a process plant comprising an engineering station server as claimed in claim 10, and at least one operator station server; wherein the operator station server is configured to transmit operator control and monitoring of the process plant created by the computer-implemented configuration tool on the engineering station server to at least one operator station client for visual display.

14. A control system for a process plant comprising the first and second engineering station servers as claimed in claim 11, and at least one operator station server; wherein the at least one operator station server is configured to transmit operator control and monitoring of the process plant created by the computer-implemented configuration tool on the first and second engineering station servers to at least one operator station client for visual display.

15. A method for displaying operator control and monitoring of a process plant via a computer-implemented configuration tool implemented on an engineering station server, the method comprising:
a) generating automation for a plurality of process components for the process plant by a first tool component of the computer-implemented configuration tool, the first tool component assigning parameterization and interaction with further process components to each process component during generation of the automation;
b) providing the automated process component, along with its parameterization and its interaction with further process components, for a second tool component of the computer-implemented configuration tool by the first tool component;
c) generating operator control and monitoring for the plurality of process components of the process plant by the second tool component based on the automated process components obtained from the first tool component; and
d) transmitting the generated operator control and monitoring to an operator station client of an operator station server of the process plant based on a previously generated operator control and monitoring and visual display of the operator control and monitoring via the operator station client;
wherein the first tool component in each case provides the second tool component with the automated process component, along with its parameterization and its interaction with further process components, such that the second tool component is not required to make any adjustments to the automated process component in order to integrate the automated process component into the operator control and monitoring of the plurality of process components of the process plant; and
wherein the automated process component is provided to the second tool component by a displacement operation which is triggerable by a project engineer of the process plant and represents a graphical dragging movement or a copy and paste operation.

16. The method as claimed in claim 15, wherein the second tool component offers the project engineer of the process plant a selection option upon acceptance of the automated process component such that the project engineer can select an embodiment of the automated process component for the operator control and monitoring from a plurality of options.
